(19) United States
(12) Patent Application Publication
(10) Pub. No.: US 2026/0014671 A1
(43) Pub. Date: Jan. 15, 2026

(54) ACCESSORY FOR BENCH BLOCK

(71) Applicant: New Revo Brand Group, LLC, Plymouth, MN (US)

(72) Inventors: Matthew C. Morris, Minneapolis, MN (US); Ryan Smith, Woodbury, MN (US); Ryan Chernik, New Brighton, MN (US); Ryan Jacobson, Andover, MN (US); Jim Hofman, Eden Prairie, MN (US); Howard Tripp, Plymouth, MN (US); Dustin Sanchez, Minneapolis, MN (US)

(21) Appl. No.: 18/766,748

(22) Filed: Jul. 9, 2024

(51) Int. Cl. B25B 5/14; B25B 5/02

(52) U.S. Cl. CPC B25B 5/14; B25B 5/02

(57) ABSTRACT

A work device can include a bench block clamping device having a post and a bridge, wherein the post secures in a mounting hole of a bench block, and the bridge connects on a first end to the post and has a suspended portion between the first end and a second end. The post can be comprised of a first material, and the bridge can be comprised of a second material that is more malleable than the first material. The work device can further include a second post connected to the second end of the bridge. The bench block can define a first recess having a first through-hole, wherein the suspended portion of the bridge spans across the width of the first recess when the post is secured within the mounting hole.

### FIELD OF THE INVENTION

This disclosure relates to accessories for bench blocks, and more particularly, relates to accessories that can assist with clamping or holding down objects being worked upon on a bench block.

### BACKGROUND OF THE INVENTION

During maintenance or construction activities, objects being worked upon in a vise are often held or otherwise supported by supports, clamps, jigs, vises, or other mechanical support arrangements. This can free up a user's hands for performing maintenance/construction tasks and can ensure the object being worked upon stays in place. However, certain objects being worked upon occasionally need to be laid on their side and vise jaws are not well-suited to those tasks. While bench blocks are useful for objects laid on their side, there are not currently ways to secure the object to the bench block while the object is being worked upon. Therefore, it is desirable to provide an accessory for a bench block that can secure the object directly to the bench block, even when an object is laid on its side.

### SUMMARY OF THE INVENTION

This disclosure relates to accessories for working devices, and more particularly, relates to accessories that can assist with clamping or holding down objects being worked upon on a bench block. In an illustrative but non-limiting example, the disclosure provides a work device comprising a bench block clamping device having a post and a bridge. The post can be structured and configured to threadedly secure within a mounting hole in a bench block and can be comprised of a first material. The bridge can be connected on a first end to the post and can have a suspended portion between the first end and a second end. The bridge can have a length that is perpendicular to a length of the post. Additionally, the suspended portion of the bridge can span across a width of a first recess of the bench block when the post can be secured within the mounting hole in the bench block. The bridge can be vertically adjustable along the post and can be rotatingly adjustable at its connection point to the post. While the post can be comprised of the first material, the bridge can be comprised of a second material that is more malleable than the first material.

In some cases, the suspended portion of the bridge can have two engaging faces located on opposing top and bottom sides of the bridge, and the bridge can be reversible on the post such that either the top or the bottom side of the bridge faces downward when the post is secured within the mounting hole in the bench block.

In some cases, the bridge is connectable to the post on either the first end or the second end of the bridge. Further, an engaging face of the bridge can be located on the suspended portion between the two connection ends, and the two connection ends can be comprised of the first material.

In some cases, a second post can be connectable to the second end of the bridge. Additionally, the second post can be structured and configured to threadedly secure within a second mounting hole in the bench block.

In some cases, the work device can further include a locking device that can be affixed to the post, and the bridge can be located between the locking device and the bench block when the post is secured within the mounting hole on the bench block. In other cases, the work device can further include a bench block that has a first recess of a top side of the bench block, the first recess including a first through-hole positioned within the first recess, and the at least one mounting hole.

In another illustrative but non-limiting example, the disclosure provides a work device comprising a bench block and a vertically adjustable clamping device. The bench block can have a receiving core, a top side, and a bottom side. The vertically adjustable clamping device can have a post and a bridge. The receiving core can define at least a first recess on the top side configured to securely receive a device component for performance of a maintenance operation, a first through-hole positioned within the first recess of the receiving core, and at least one mounting hole. The first through-hole can be configured such that when a securing component is removed from the device component, the securing component can pass through the first through-hole from the top side to the bottom side of the receiving core. The post of the vertically adjustable clamping device can be structured and configured to secure within the at least one mounting hole in the bench block. The bridge of the vertically adjustable clamping device can be connected on a first end to the post and can have a suspended portion between the first end and a second end, wherein the bridge can have a length that spans across a width of the first recess when the post is secured within the at least one mounting hole.

In some cases, the securing component can be a pin. And in some cases, the bridge can have an adjustable height along the post, and the clamping device can further be comprised of a locking mechanism that can secure the bridge at a maximum height. In some cases, the bench block can further include a tray and a locking mechanism. The tray can be magnetized and can be comprised of designated engagement portions that hold predetermined tools in place. The locking mechanism can be a slide lock.

In some cases, the at least one mounting hole and the post can be threadedly connected. Further, the bench block can have a second recess on the top side configured to securely receive a device component for performance of a maintenance operation. Additionally, the at least one mounting hole can be positioned between the first recess and the second recess such that the bridge, when the post is secured within the mounting hole, can span across the width of the first recess when the bridge is in a first position, and can span across a width of the second recess when the bridge is in a second position.

In some cases, the bench block can have a first mounting hole and a second mounting hole, and the mounting holes can be compatible with the post of the clamping device. Further, the first mounting hole and the second mounting hole can be positioned opposite each other on either side of the first recess. Additionally, the work device can be comprised of a second post that is structured and configured to secure within either of the mounting holes. Therefore, the post of the first vertically adjustable clamping device can be secured within the first mounting hole, and the second post can be secured within the second mounting hole. As such, the posts can be threadedly connected to their respective mounting holes, the bridge of the first vertically adjustable clamping device can have an adjustable height along the first post, and the bridge of the first vertically adjustable clamping device can have a first end connected to the first post and a second end connected to the second post.

In another illustrative but non-limiting example, the disclosure provides a work device having a bench block and a vertically adjustable clamping device. The bench block can have a receiving core, a top side, and a bottom side. The vertically adjustable clamping device can have a first post, a second post, and a bridge. The receiving core can define at least a first recess on the top side configured to securely receive a device component for performance of a maintenance operation, a first through-hole positioned within the first recess of the receiving core, and a plurality of mounting holes. The first through-hole can be configured such that when a securing component is removed from the device component, the securing component can pass through the first through-hole from the top side to the bottom side of the receiving core. The first post of the vertically adjustable clamping device can be structured and configured to secure within a first mounting hole. The second post can be structured and configured to secure within a second mounting hole. The bridge can be connected to the first post and the second post and can have a suspended portion that spans across a width of the first recess when the posts are secured within the first and the second mounting holes.

The above summary is not intended to describe each and every example or every implementation of the disclosure. The Description that follows more particularly exemplifies various illustrative embodiments.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 is a perspective top view of a bench block having two clamping devices secured in the bench block.

FIG. 2 is a top plan view of a bench block having two clamping devices secured in the bench block.

FIG. 3 is a bottom perspective view of a bench block having two clamping devices secured in the top of the bench block and two additional clamping devices secured to the bottom of the bench block for storage.

FIG. 4 is a bottom plan view of a bench block having two clamping devices secured in the top of the bench block and two additional clamping devices stored secured to the bottom of the bench block for storage.

FIG. 5 is an elevational side view of a bench block having two clamping devices secured in the bench block.

FIG. 6 is a top perspective view of a bench block tool kit that is compatible with the bench block clamping device.

FIG. 7 is a bottom perspective view of a bench block tool kit that is compatible with the bench block clamping device

FIG. 8 is a top view of the bench block clamping device.

FIG. 9 is a bottom view of the bench block clamping device.

FIG. 10 is a front view of the bench block clamping device.

FIG. 11 is a back view of the bench block clamping device.

FIG. 12 is a right side view of the bench block clamping device.

FIG. 13 is a left side view of the bench block clamping device.

FIG. 14 is a perspective view of the bench block clamping device.

FIG. 15 is an exploded view of the bench block clamping device.

### DETAILED DESCRIPTION

This disclosure relates to accessories for bench blocks, and more particularly, relates to accessories that can assist with clamping or holding down objects being worked upon on a bench block. Various embodiments are described in detail with reference to the drawings, in which like reference numerals may be used to represent like parts and assemblies throughout the several views. Reference to various embodiments does not limit the scope of the systems and methods disclosed herein. Examples of construction, dimensions, and materials may be illustrated for the various elements, those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

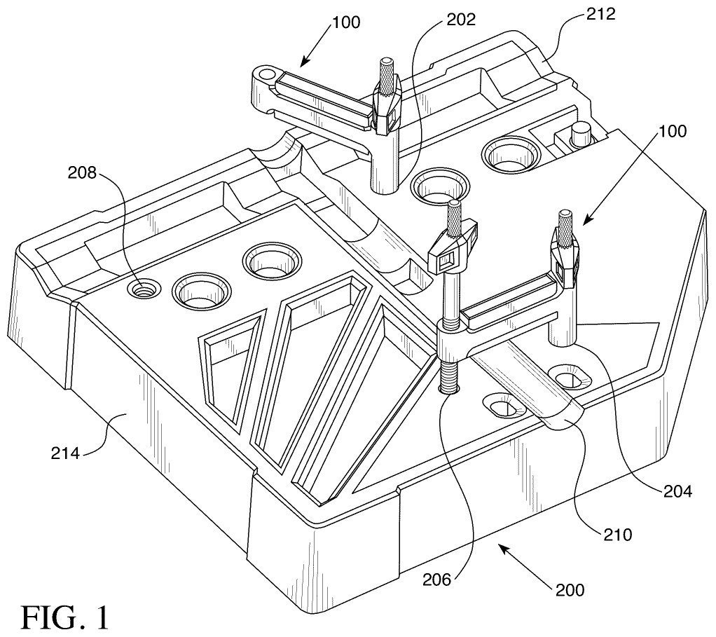

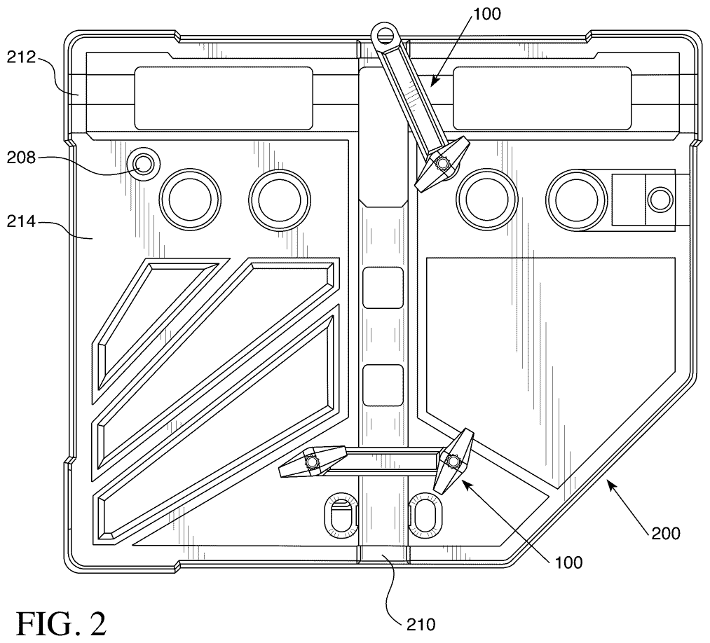

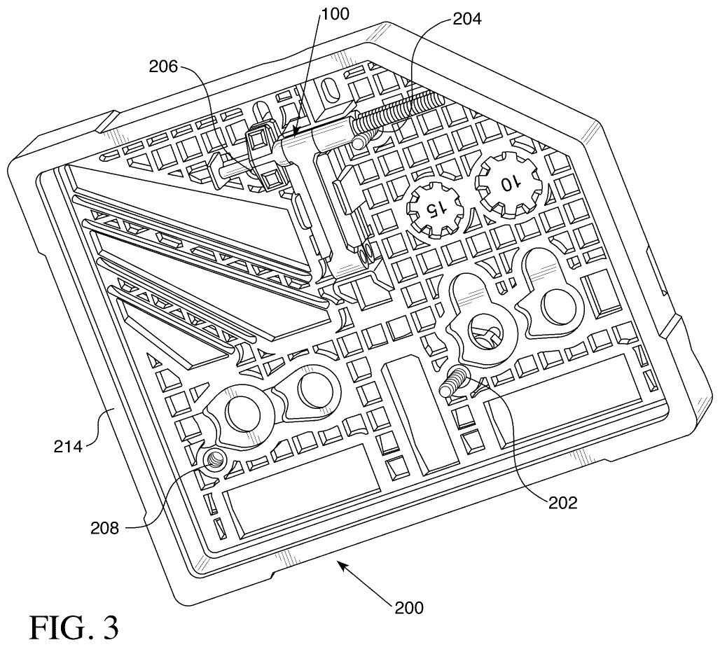

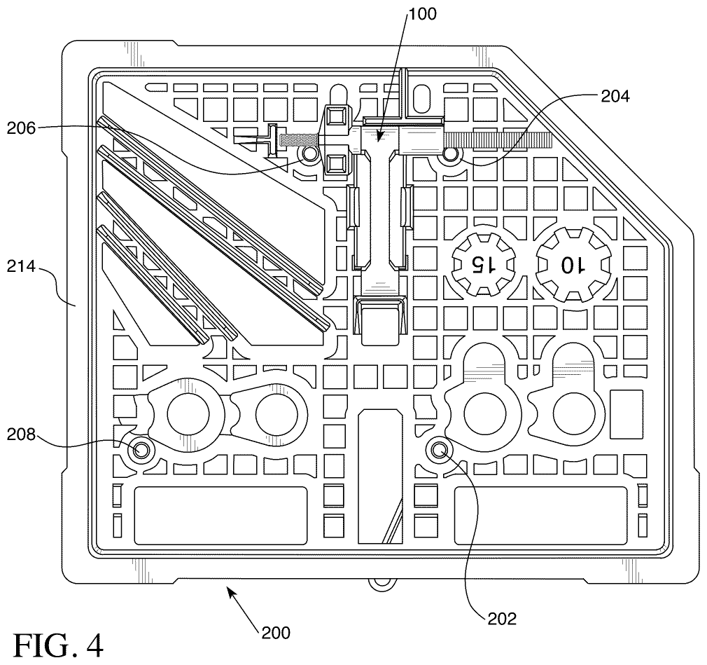

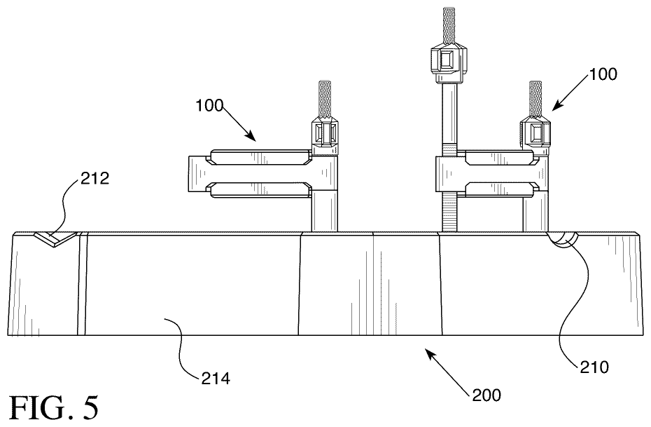

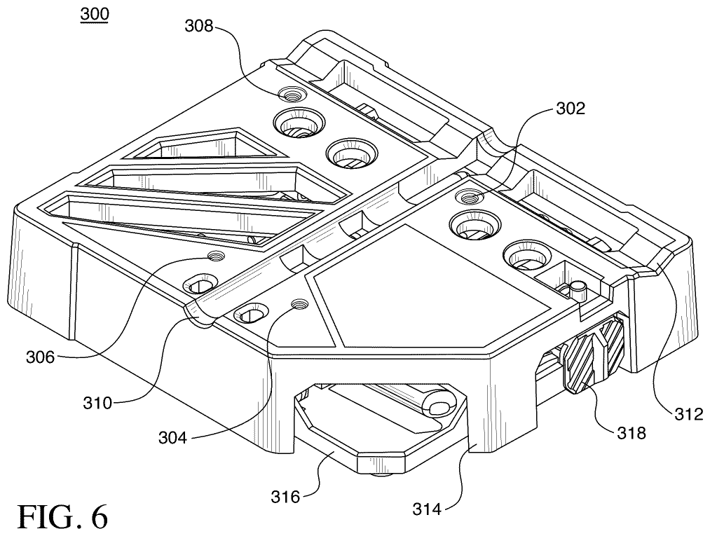

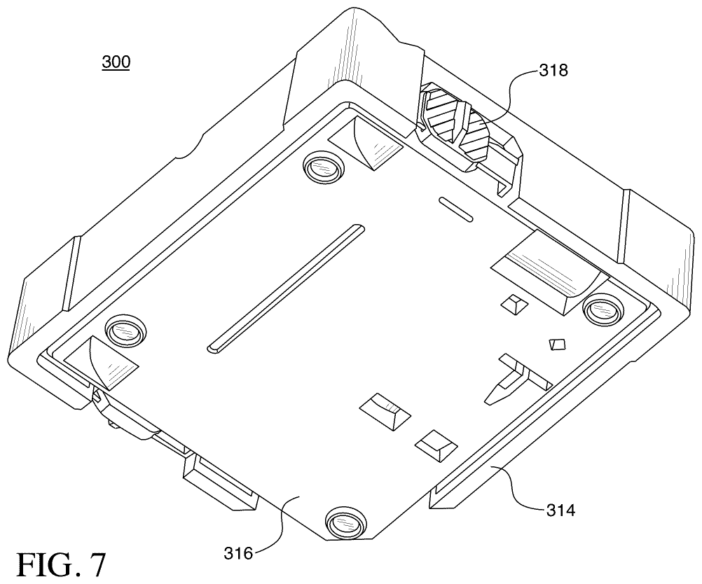

The present disclosure describes a bench block clamping device that can aid users in firmly supporting a device on a bench block for performance of a maintenance or assembly operation. FIGS. 1-7 illustrate one or more bench blocks that are compatible with the disclosed bench block clamping devices. FIG. 1 is a perspective top view of a bench block having two clamping devices secured in the bench block. FIG. 2 is a top plan view of a bench block having two clamping devices secured in the bench block. FIG. 3 is a bottom perspective view of a bench block having two clamping devices secured in the top of the bench block and two additional clamping devices secured to the bottom of the bench block for storage. FIG. 4 is a bottom plan view of a bench block having two clamping devices secured in the top of the bench block and two additional clamping devices stored secured to the bottom of the bench block for storage. FIG. 5 is an elevational side view of a bench block having two clamping devices secured in the bench block. FIG. 6 is a top perspective view of a bench block tool kit that is compatible with the bench block clamping device. FIG. 7 is a bottom perspective view of a bench block tool kit that is compatible with the bench block clamping device.

Clamping devices of the present disclosure can connect to a bench block using a threaded post and can clamp down on objects using a vertically adjustable bridge. The bridge can include a first end for connecting to the post and a suspended portion that is perpendicular to the post and spans across a width of a first recess of the bench block when the post is secured within the bench block. As described further herein, the bench block clamping device can be comprised of at least two or more materials, a first of which the post can be comprised, and a second of which the bridge can be comprised, wherein the second material can be more malleable than the first material.

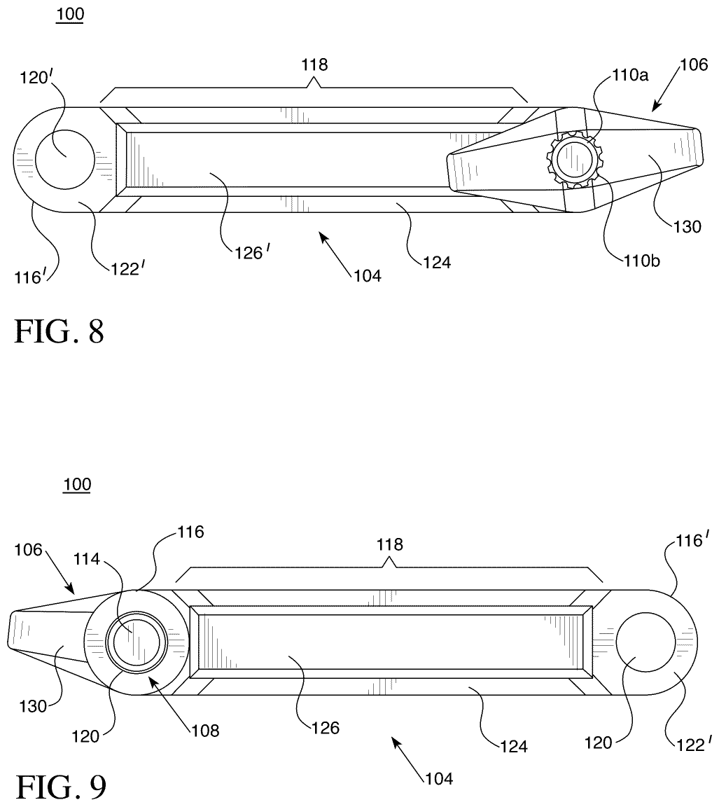

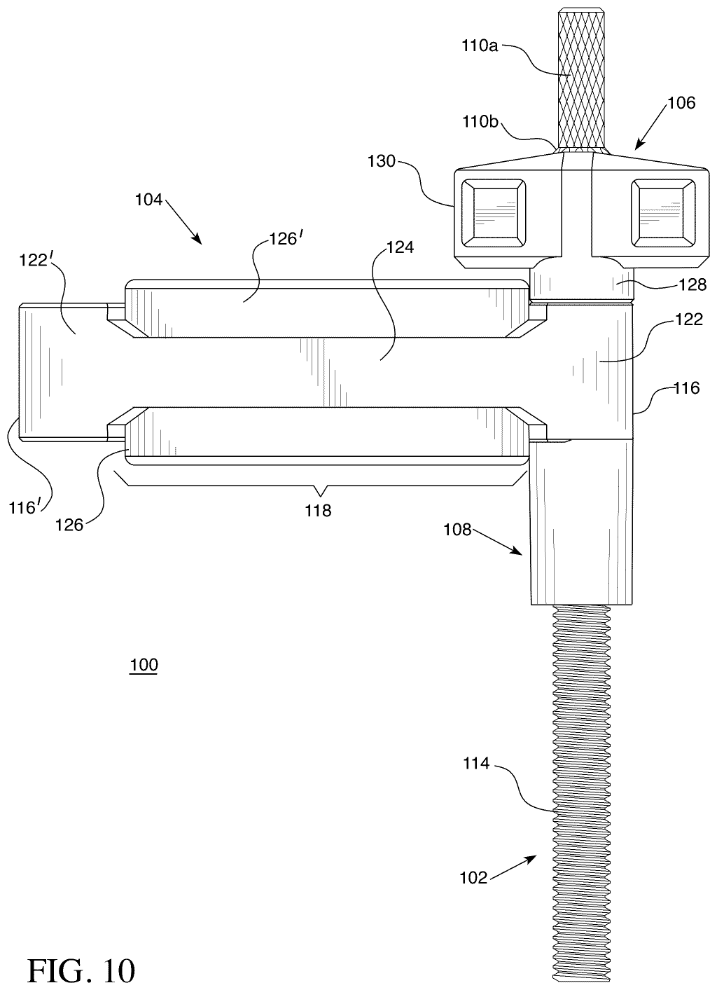

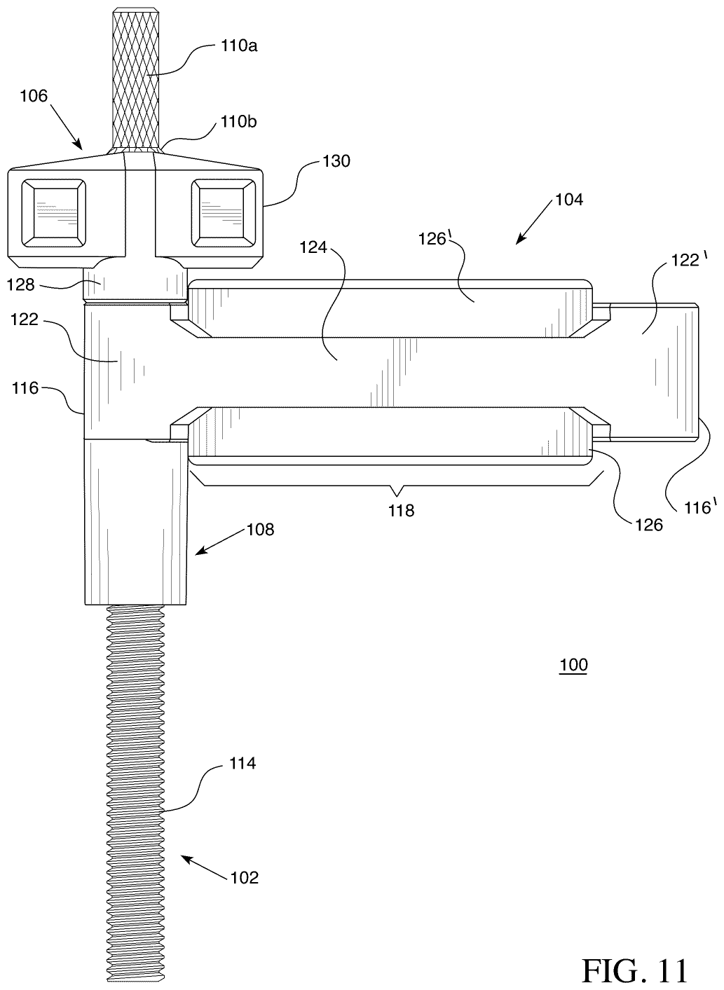

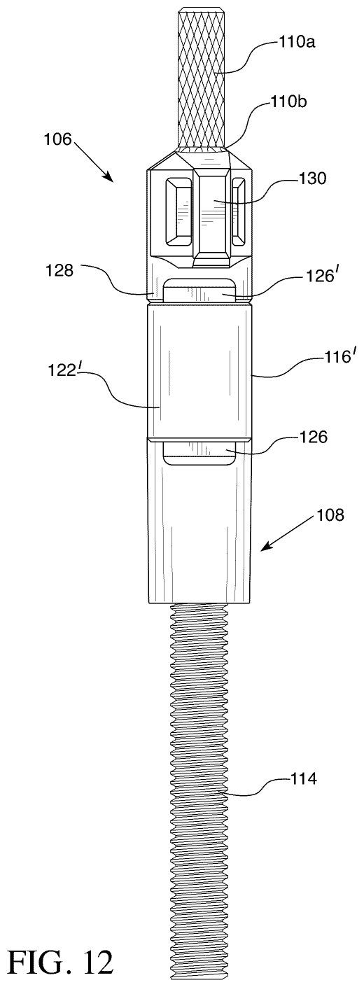

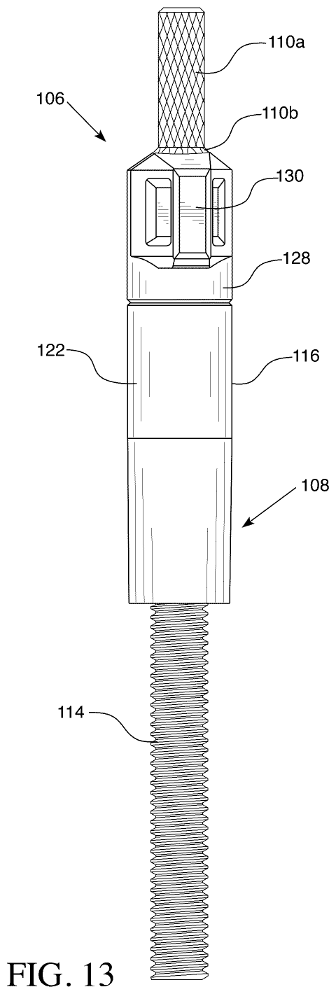

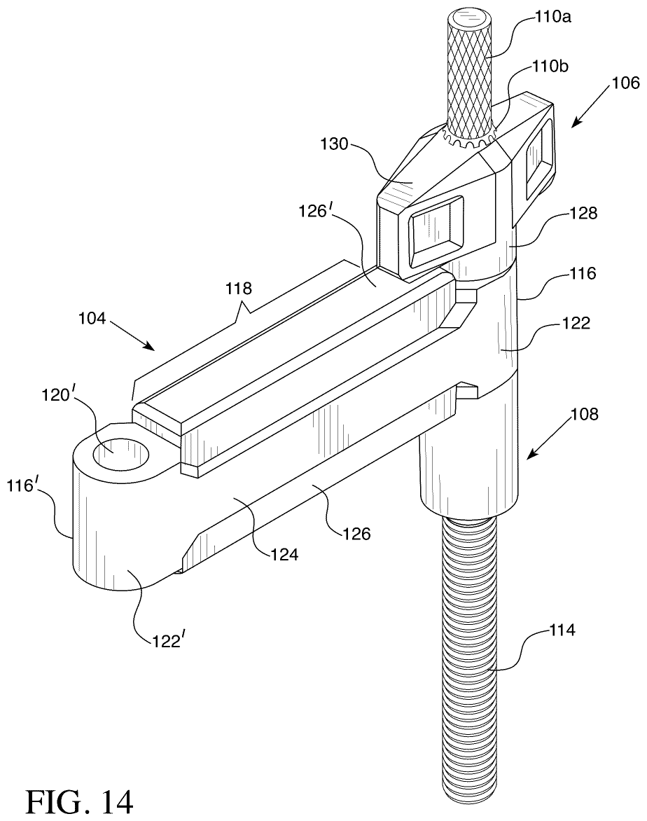

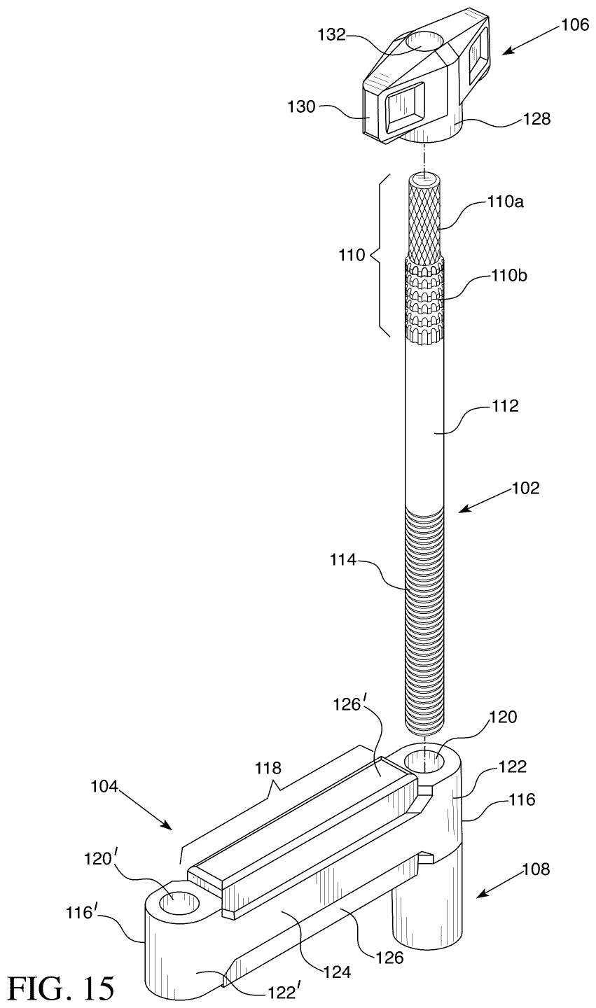

FIGS. 8-15 illustrate the bench block clamping devices of the present disclosure. FIG. 8 is a top view of the bench block clamping device. FIG. 9 is a bottom view of the bench block clamping device. FIG. 10 is a front view of the bench block clamping device. FIG. 11 is a back view of the bench block clamping device. FIG. 12 is a right side view of the bench block clamping device. FIG. 13 is a left side view of the bench block clamping device. FIG. 14 is a perspective view of the bench block clamping device. FIG. 15 is an exploded view of the bench block clamping device.

As mentioned above, the bench block clamping device of the present disclosure can be comprised of a post and a bridge. The bench block clamping device can further be comprised of locking device and a stop, wherein the bridge, locking device, and stop can all be mounted on the post. For example, as illustrated herein, the bridge 104 can be connected to the post 102 so that it is positioned between the stop 108 and the locking device 106, with the stop being located between the bridge and the bench block 200, 300 when the bench block clamping device is installed on a bench block. This positioning allows the bridge to be locked at a specific height above the bench block such that it will not move up or town along the post until the locking device is released. In this manner, the bench block clamping device can securely clamp an object between the bench block and the bridge of the clamping device.

As illustrated in FIG. 14, the post 102 can be a cylindrical shaft and it can be comprised of a metal (for example, steel, stainless steel, brass, titanium, or an aluminum alloy) or a composition of metals. Additionally, the post can be at least partially threaded to engage with a threaded mounting hole on the bench block. In some cases, the post can also be at least partially non-threaded throughout at least one other portion.

More specifically, the post 102 can have a top, non-threaded portion 110 followed by a second non-threaded portion 112, and lastly, a threaded portion 114 that continues to the bottom of the post (while “top” and “bottom” are used herein to refer to the ends of the post, it is intended that the post be reversible such that, in use, the “top” may end up at the bottom and the “bottom” may end up at the top). The threaded portion 114 can be the longest portion of the post 102 to allow for a user to significantly vary the height of the bridge 104. The second non-threaded portion 112 can be the second longest portion, and the first non-threaded portion 110 can be the shortest. In some cases, however, the first and second non-threaded portions may be of similar length. In other cases, the first non-threaded portion 110 may be comprised of two sections 110a, 110b having different textures, wherein both sections are shorter than the second non-threaded portion.

For example, the topmost portion of the first non-threaded portion 110 (i.e., the top of the post, herein referred to as the upper end 110a of the first non-threaded portion) can be smooth or slightly textured, and the bottom portion of the first non-threaded portion (herein referred to as the lower end 110b of the first non-threaded portion although, when the post is reversed, the lower end may be positioned “above” the “upper end”) can be heavily textured or knurled such that it has deeper and wider valleys than the upper end. This configuration of the post is intended to accommodate the other components of the bench block clamping device.

Specifically, the first non-threaded portion 110 can be structured and configured to be gripped by a user when the user is threadedly securing the bench block clamping device 100 to the bench block 200, 300. The cylindrical shape enables a user to spin the threaded post 102 quickly around, thereby securing is to the object being worked upon in an expeditious manner. Therefore, the first non-threaded portion 110 can be smooth or textured (for example, knurled) to prevent a user's grip from slipping on the post 102 when tightening the clamping device 100 on the bench block 200, 300.

Additionally, in embodiments where the first non-threaded portion 110 is comprised of two different sections, the lower end 110b may have more significant texturing than the upper end 110a that is exposed to the user. For example, as mentioned above, the lower end 110b may have deeper and wider valleys into which the locking device 106 can be paired or secured. This enables the lower end 110b of the first non-threaded portion 110 to interlink with the locking device 106 and restrict rotation of the locking device on the post 102. In some cases, the locking device may be over-molded directly onto the lower end of the first non-threaded portion so that it can resist rotational movement around the post. For example, as illustrated in FIGS. 10-15, the locking device 106 may be a wingnut that is permanently affixed to the post 102. When a user is securing the clamping device 100 to a bench block and the torque increases to a point where pinching the post 102 to turn the clamping device becomes difficult, the user can switch their grip from the upper end 110a of the post to the locking device 106 and obtain additional torque with which to secure the device being worked upon between the bench block and the clamping device.

Whereas the first non-threaded portion 110 may be intended to reduce movement between the post and the user or clamping device components that interact with it, the second non-threaded portion 112 can be structured to enable the end of the bridge 104 to easily slide along it as well as easily spin around the post 102 without changing height (as it would have to if it were threadedly connected) and can therefore have a smooth texture to enable such movement, as illustrated in FIG. 15. This also enables the clamping device to be reversible, such that the post can easily be pulled out of the top of the bridge and reinserted into the bottom (or vice versa). As described below, this may be useful in situations where the bridge is not symmetrical such that the top part of the bridge has components that are different sizes or materials than the bottom part of the bridge.

Lastly, as mentioned above, the threaded portion 114 can be structured to engage with a mounting hole in a bench block 200, 300, as illustrated in FIGS. 1-5, and its length can enable the clamping device to lock at various distances from the bench block so as to accommodate various heights/thicknesses of devices being worked upon. The additional bench block clamping device components, such as the bridge, the locking device, and their various subcomponents, will all be discussed further herein.

The bridge 104 can be comprised of at least one connection end 116 for connecting to the post 102, and a suspended portion 118 for clamping down on the object being worked upon. In some cases, both ends of the bridge may be connection ends such that either end is connectable to the post. In those cases, if the bench block has corresponding mounting holes, the bridge can be connected to two posts at once, one on each of its ends, as illustrated in FIG. 1. The suspended portion of the bridge can be perpendicular to the post, as illustrated in FIGS. 5 and 10-11, and can have a length that can span across a width of a recess on a bench block when the post is secured within a mounting hole of the bench block, as illustrated in FIGS. 1-2.

In some embodiments, the connection end 116 of the bridge 104 can be approximately cylindrical, have openings 120 on both its top and bottom ends, and can be hollow such that the post 102 can be inserted completely through the connection end. The interior surface of the openings 120 and the hollow portion of the connection end 116 can be smooth, such that the interiors will not catch or snag on the post 102 when it is inserted into or removed from the connection end. While the connection end shown in the figures has a smooth interior to allow the post to simply slide through it, it is envisioned that, in some cases, the interior may be threaded to engage with the post or be otherwise textured or layered with a secondary material that varies from the primary material of which the connection end is comprised of.

The material(s) that can comprise the connection end includes, but is not limited to, plastic (for example, high-density polyethylene, polyvinyl chloride, polypropylene, other thermoplastic polymers, etc.), metals (for example, steel, stainless steel, brass, titanium, or an aluminum alloy), engineering resin that resists breakage or deformation yet will not mark or mar metal parts with which it comes into contact, high durometer rubber, nylon, or any other rigid material or combination of materials that enables the connection end(s) to resist folding, bending, or otherwise forcing of the connection end out of shape without the use of tools. As mentioned above, while the connection end illustrated herein is comprised of a single material (or composition of materials), in some cases the connection end may have a secondary material on its exterior and/or interior surfaces.

Additionally, while the connection end has been described herein in the singular in terms of its features and functionality, in embodiments having two connection ends, it is anticipated that the features and descriptions of the singular connection end can also apply to both connection ends. However, while both ends may share similarities in terms of shape and construction, in some cases, there may be some variability. For example, as illustrated in FIGS. 10-11, a first connection end 116 can be taller than a second connection end 116′.

In some cases, the connection end 116 be one continuous component that is molded from a singular part having two components: a primary connection piece 122 that connects to the suspended portion 118 and a stop 108 that prevents the suspended portion from coming into contact with the bench block. Similarly, if there are two connection ends 116, 116′, then both ends may include a primary connection piece 122, 122′ respectively, although only one may include a stop 108. In some cases, the primary connection piece and the stop can be separately manufactured components. However, even if the connection end is one continuous component, a lower portion of the connection end may still function as a stop. In cases whether the connection end is comprised of two components, the primary connection piece and the stop may be manufactured and assembled such that they substantially cannot be separated nondestructively. In other cases, the primary connection piece and the stop may be manufactured separately, and structured and configured to be fit together after manufacture.

As illustrated herein, a connection end can be shorter than the height of the suspended portion of the bridge. For example, connection end 116′ is shorter than the suspended portion 118 Alternatively, a connection end can be taller than the height of the suspended portion of the bridge. For example, connection end 116 is taller than the suspended portion 118. This height difference between the connection end 116 and the suspended portion 118 can allow for the bridge 104 to have a minimum height or distance from the bench block. And in embodiments where the clamping device has two connection ends on either end of the suspended portion, the connections ends may have the same (or similar) height or, alternatively, one connection end may be shorter than the other connection end. For example, as illustrated, the connection end 116′ may be shorter than the connection end 116. Further, the connection end 116′ may be shorter than the height of the overall suspended portion 118 (albeit taller than a central frame 124 of the suspended portion), and the other connection end 116 may be taller than the height of the overall suspended portion.

As mentioned above, in addition to one or more connection ends, the bridge may be comprised of a suspended portion. The suspended portion of the bridge can be relatively narrow and long such that, front a top or bottom view, the suspended portion looks approximately rectangular, as illustrated in FIGS. 8-9, with the suspended portion being longer than it is wide. A front and back view of the suspended portion of the bridge may also illustrate an approximately rectangular shape with the suspended portion being longer than it is tall. As illustrated in FIGS. 10-11, the suspended portion may be taller than it is wide. In some embodiments, the suspended portion may be comprised of a single material. In other embodiments, the suspended portion may be comprised of multiple materials.

For example, the suspended portion 1108 can be comprised of a frame 124 having a first material and at least one engagement face 126 having a second material. The frame can be made of a similar material to the connection end. For example, the frame can be comprised of plastic (for example, high-density polyethylene, polyvinyl chloride, polypropylene, other thermoplastic polymers, etc.), metals (for example, steel, stainless steel, brass, titanium, or an aluminum alloy), engineering resin that resists breakage or deformation yet will not mark or mar metal parts with which it comes into contact, high durometer rubber, nylon, or any other rigid material or combination of materials that enables the frame to resist folding, bending, or otherwise forcing of the frame out of shape without the use of tools. In some cases where the frame and the connection end(s) are comprised of the same material, the frame and the connection end(s) may be formed from one piece. In other cases, the frame and connection ends can be manufactured separately, and structured and configured to be fit together after manufacture.

In cases where the frame and the connection end(s) are not comprised of the same material, the engagement face can be of a softer, more malleable material than the frame such that it can easily be deformed by the object being worked upon. Additionally, the material of the engagement face can be, for example, a non-slip material providing a high friction coefficient. Materials with these properties can include, but are not limited to, foam (for example, M. foam, #13 foam, or #7 foam) or a natural or synthetic rubber or similar material. A rubber material can exhibit useful properties for the contact parts, including tackiness or high-friction between the contact part and the device being worked upon. Therefore, when the bench block clamping device is clamped onto an object being worked upon, the engagement face can deform to secure the object in place and to avoid marring the object and can have a tackiness that prevents the device from slipping away from the clamp.

In cases where the suspended portion is comprised of a frame having a first material and at least one engagement face having a second material, the frame and the engagement face(s) can be overmolded such that they substantially cannot be separated non-destructively. In some other cases, however, the frame and the engagement face(s) can be manufactured separately, and structured and configured to be fit together after manufacture.

While the above embodiments describe a single engagement face, some embodiments of the suspended portion 118 may include a frame 124 with two engagement faces 126, 126′, as illustrated in FIGS. 10-11 and 14-15. A first engagement face 126 may be located on a bottom portion of the frame 124, and a second engagement face 126′ may be located on a top portion of the frame. The engagement faces 126, 126′ may be similar heights and comprised of the same material or combination of materials or, alternatively, they may have different heights and/or be comprised of different materials or combinations of materials. For example, the engagement faces may both be comprised of rubber, but they may have different durometer readings such that one may be more malleable or soft than the other. In another example, the engagement faces may have different heights such that one may allow an object being worked upon to deform further than the other before reaching the frame. In embodiments having two engagement faces (and even in embodiments with only one engagement face), the bench block clamping device can be reversible such that the top engagement face can be facing downward, and the bottom engagement face can be facing upward.

To enable this reversal of the clamping device, the top of the bridge can have an opening and through hole on at least one end to receive the post. More specifically, as mentioned above, the top of the connection end 116 can include a hole 120 that continues through the connection end and out the bottom of the connection end, thereby enabling the post 102 to slide all the way through and exit out the other side of the connection end. It is envisioned that the post could also enter the bottom of the connection end and exit out the top of the connection end, thereby enabling the bench block clamping device to be reversible. Therefore, as illustrated in FIG. 15, the top of the bridge 104 can have at least one opening 120, 120′ and an engaging face 126. The opening 120 or 120′ can be on at least one end (for example, on the connection end 116 or 116′) and can receive the post 102 (or allow the post to exit), and the engaging face 126′ can be positioned on a top surface of the suspended portion 118. The bottom of the bridge 118 can also have an opening and an engaging face 126. The opening can be a continuation of the opening 120, 120′ from the top of the bridge 104 that can receive the post 102 (or allow the post to exit), and the engaging face 126 can be positioned on a bottom surface of the suspended portion 118.

As mentioned above, the bridge may not have an engaged connection (for example, a threaded connection) to the post so it may simply be able to slide up and down the post. Therefore, to enable the height of the suspended portion to be secured at least a minimum height above a bench block's surface, the bench block clamping device may further include a stop. The stop 108, as mentioned above, can be a continuation of the connection end 116 (i.e., molded from one part) or it can be a separate component from the primary connection piece 122. Additionally, the stop can include an opening hole that is an extension of the opening/hole in the connection end such that the post can slide all the way through the connection end and the stop in one continuous motion. In some embodiments, such as when there is only one connection end or, as illustrated, if there are two connection ends on either end of the suspended portion, the stop may be located on a single connection end. In other embodiments, such as when there are two connections ends, there may be two stops; one on each connection end. While the stop can help prevent the bridge from sliding down the post all the way to the top surface of the bench block, an additional locking device may be helpful to prevent the bridge from inadvertently sliding upwards and off of the object being worked upon.

More specifically, to hold the bridge down and clamp the object being worked upon in place, the bench block clamping device can include a locking device. The locking device can be located on the post, and can be, for example, a wing-nut or other grippable component. Therefore, when a user threads the post onto the bench block, the bridge can be located between the bench block and the locking device such that as the post is threaded further into the bench block, the space between the locking device and the surface of the bench block will decrease. Once the object being worked upon is sandwiched between the bench block and the bridge or, alternatively, the connection end or stop makes contact with the bench block, the user can clamp the clamping device down further and lock it in position by gripping the locking device and twisting the post further. The locking device can be permanently affixed to the post (for example, overmolded onto the post) or it could be threadedly engaged with the post.

The locking device 106, in the case of a wing-nut, can have a main body 128 affixed to the post 102 (for example, the main body can be affixed to the lower end 110b of the first nonthreaded portion 110 of the post) and a gripping point 130 (for example, two wings that are oppositely positioned each other across the main body) that allows a user to easily grasp on to the locking device and twist. However, this configuration is not a requirement, and the gripping point can be any enlarged portion that simply allows a user to have a larger gripping area than the post allows for. For example, the gripping point can be cylindrical, cog-shaped (with peaks and valleys), t-shaped, or any other geometrical shape. In some cases, the locking device 106 can be overmolded onto the post 102, as mentioned above and illustrated herein. In other cases, the locking device may be an extension of the post such that they are molded from the same part.

In cases where the locking device and the post are comprised of the same part, the locking device and the post may be formed from the same material or combination of materials. In cases where the locking device and the post are manufactured as separate parts and are either structured and configured to be fit together after manufacture or then manufactured to be inseparable without destroying either or both pieces (for example, via overmolding), the pieces can be made from the same material or combination or materials, or the pieces can be made from different materials. As mentioned above, the post can be comprised of a metal (for example, steel, stainless steel, brass, titanium, or an aluminum alloy) or a composition of metals. Therefore, the locking device can be comprised of a metal or composition of metals, or it can be comprised of plastic (for example, high-density polyethylene, polyvinyl chloride, polypropylene, other thermoplastic polymers, etc.), engineering resin that resists breakage or deformation yet will not mark or mar metal parts with which it comes into contact, high durometer rubber, nylon, or any other rigid material or combination of materials that enables the frame to resist folding, bending, or otherwise forcing of the frame out of shape without the use of tools.

In use, the post 102 can be inserted into an opening 120, 120′ in either the top or bottom of the bridge 104 and can slide completely through such that a top portion of the post is protruding out of the top of the bridge and a bottom portion of the post is protruding out the bottom of the bridge. In cases where a locking device 106 is present, the locking device can be positioned above where the bridge 104 is connected to the post 102. As described above, the opening and hole 120, 120′ in the connection end 116, 116′ of the bridge 104 may have a smooth internal face such that the post 102 can simply slide through the bridge. Therefore, after sliding the post 102 through the bridge 104, the post can be threaded onto a bench block at a predetermined mounting hole. The user can simply twist the post 102 around (for example, in a clockwise position) in order to move the post further into the bench block and, therefore, move the bridge 104 closer to the top surface of the bench block. With an object positioned between the bench block and the bridge 104, the post 102 can be twisted until the engagement face 126, 126′ of the suspended portion 118 of the bridge engages with the object. At that point, if a locking device 106 is present, a user can grip the locking device to obtain better torque and continue twisting. In cases where the locking device is not rotatable around the post, the twisting action of the locking device can cause the post to twist further into the bench block and can place additional clamping pressure on the object, thereby securing it in place on the bench block.

In situations where a user wishes to place a lot of torque or pressure on the object being worked upon, they may also wish to insert a second post, to ensure the bridge does not move or flex when it is clamped down on the object. In that case, after twisting the first post into place on the bench block, the user can take a second post, insert it through a second opening/hole in the bridge (for example, a second connection end opposite the first connection end), and thread it into a second predetermined mounting hole on the bench block. In the same manner as with the first post and locking device, the user can twist the post in a first direction (for example, clockwise) until it becomes difficult to continue pinching the post and spinning it freely with the user's hand. At that point, the user can grip the second locking device and apply additional torque until the post is applying a desired pressure on the connection end.

When a user is finished working on the object, they can then twist the post(s) the opposite direction (for example, in a counterclockwise position) in order to relieve the pressure the bridge is placing on the object, and the user can then either pull the object out from the position on the bench block or continue twisting the post until the post is completely removed from the bench block.

As illustrated in FIGS. 1-7, a receiving core of a bench block can have a plurality of threaded mounting holes that are compatible with the post. For example, if a receiving core has one or more recesses, then the receiving core can have at least one mounting hole next to each recess. Some receiving cores may have at least two recesses on the top side of the bench block and those recesses may further include through-holes.

As illustrated in FIGS. 1 and 6, two of the at least two recesses of the receiving core 214 may create a “T” such that a first end of one recess 210, 310 merges into a center portion of a second recess 212, 312. Mounting holes may be located at several spots on the receiving core 214 including, but not limited to, a corner near the intersection of the two recesses and/or near an end of either or both recesses. The through-holes in the recesses can be positioned such that when a securing component (for example, a pin) is removed from the device component, the securing component can pass through a through-hole in a recess from the top side to the bottom side of the receiving core 214, 314. In some embodiments, through-holes may be positioned elsewhere on the receiving core 214, 314 other than the recesses, as illustrated in FIGS. 1-7.

As illustrated, receiving cores 214, 314 can include one mounting hole 202, 302 at the intersection of the two recesses (i.e., near a first end of the first recess 210, 310 and a central portion of a second recess 212, 312), a second mounting hole 204, 304 near a second end of the first recess that is along the same side of the first recess as the first mounting hole, a third mounting hole 206, 306 near the second end of the first recess that is on an opposite side of the first and second mounting holes such that the second mounting hole and third mounting hole are opposite each other across the first recess, and a fourth mounting hole 208, 308 near an end of the second recess that is along the same side of the second recess.

The positioning of the first mounting hole 202, 302 on receiving cores 214, 314 enables a bench block clamping device 100 to hold down an object that is placed within either of the first 210, 310 or second recesses 212, 312, as the bridge 104 can swivel around the post 102 from one position to another. This positioning, in combination with the positioning of the other mounting holes, enables a user to also use this as a way to have two bench block clamping devices holding down a singular object to be worked upon.

For example, if a long object is placed in the first recess 210, 310, the first mounting hole 202, 302 as well as the second 204, 304 and/or third mounting holes 206, 306 can accept a post 102 that will have a bridge 104 able to clamp down on the object. In another example, if a long object is placed in the second recess 212, 312, the first 202, 302 and fourth mounting holes 208, 308 can accept a post 102 that will have a bridge 104 able to clamp down on the object. In this manner, the object can then be clamped down at two locations regardless of whether it is placed in the first recess 210, 310 or the second recess 212, 312. Additionally, if placed in the first recess 210, 310, it may have the opportunity to have one portion of the object secured by a bridge 104 that is mounted at one or both ends.

More specifically, in some cases, the second 240, 340 and third mounting holes 206, 306 will both receive a post 102 and those posts can then connect to a first and second end of a bridge 104. Similarly, in some embodiments, a fifth mounting hole (not pictured) may be placed opposite the first mounting hole 202, 302 such that a bridge 104 spanning the first recess 210, 310 can have posts 102 connected on its first and second ends to the first 202, 302 and fifth mounting holes. In that case, an object placed in the first recess 210, 310 may have the opportunity to have two bridges 104 secured at both ends.

As illustrated herein, the bench blocks 200, 300 can also contain a storage mechanism for the bench block clamping devices 100. More specifically, the bottom side of the receiving core 214, 314 can include two living hinges that are spaced apart such that the bridge 104 can be wedged between them and held secure via a spring mechanism. As illustrated, the hinges may be deep/tall enough that more than one bridge can be secured between them. This helps prevent users from misplacing the bench block clamping devices when the user may only perhaps need use of the bench block. Therefore, in cases where the bench block includes four mounting holes and a storage mechanism, the bench block may be able to securely contain up to six bench block clamping devices at a time: one in each mounting hole and two in the storage mechanism.

In addition to being able to store the bench block clamping devices 100, the bench block 300 may be able to store tools. More specifically, as illustrated in FIGS. 6-7, the bench block 300 can include a receiving core 314 and a tray 316 in which tools can be stored. The tools can be placed in a simple, open area tray 316 and can be secured once the receiving core 314 is placed on top. Alternatively, the tray 316 can include several designated portions for predetermined tools. These portions can be cutouts embedded in the base of the tray so that the tools can precisely fit within the cutouts. Alternatively, these portions can be engagement portions have clamping fingers or living hinges that are designed to grasp specific portions of predetermined tools. The tools held in place can be hammers, hammer heads, wrenches, bits, punches, tweezers, or any other appropriately sized tools.

In use, when the device to be worked upon is placed on the bench block receiving core 314 and a securing component (such as a pin) is removed from the device component (for example, by using a punch), the securing component can pass through a through-hole in the receiving core and fall into the tray 316. Since securing components are frequently comprised from metal, to further enhance the ability of the bench block 300 to retain these securing components, the tray 316 can be magnetized. The magnet may be embedded within the tray 316, or the entire tray may be magnetized. In some cases, the walls of the tray 316 may be magnetized such that the securing components may roll around in the base of the tray, but will be attracted to, and remain attached to, the wall of the tray if they get within a predetermined distance of those walls.

When not in use, it is desirable for the receiving core 314 and tray 316 of the bench block 300 to remain attached together, thereby ensuring the tools and/or any securing components left in the tray stay confined to the bench block. The securing mechanism used for the bench block 300 can be as simple as a friction fit between the receiving core 314 and the tray 316. Alternatively, mechanical means, such as a slide lock 318 can be incorporated into the bench block 300. The slide lock 318 can be permanently attached to a bar on the tray 316 and, when the receiving core 314 is placed on the tray and a user wishes to lock them together, the user can slide the lock from one side of the bar to the other side, thereby moving the slide lock over a wedge or ledge on the receiving core and securing the two pieces to each other.

Persons of ordinary skill in arts relevant to this disclosure and subject matter hereof will recognize that embodiments may comprise fewer features than illustrated in any individual embodiment described by example or otherwise contemplated herein. Embodiments described herein are not meant to be an exhaustive presentation of ways in which various features may be combined and/or arranged. Accordingly, the embodiments are not mutually exclusive combinations of features; rather, embodiments can comprise a combination of different individual features selected from different individual embodiments, as understood by persons of ordinary skill in the relevant arts. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

What is claimed is:

1. A work device comprising:
bench block clamping device having
a post structured and configured to threadedly secure within a mounting hole in a bench block, the post being comprised of a first material, and
a bridge connected on a first end to the post and having a suspended portion between the first end and a second end,
wherein
the bridge has a length that is perpendicular to a length of the post,
the suspended portion of the bridge spans across a width of a first recess of the bench block when the post is secured within the mounting hole in the bench block,
the bridge is vertically adjustable along the post,
the bridge is rotatingly adjustable at its connection point to the post, and
the bridge is comprised of a second material that is more malleable than the first material.

2. The work device of claim 1, wherein
the suspended portion has two engaging faces located on opposing top and bottom sides of the bridge, and
the bridge is reversible on the post such that either the top or the bottom side of the bridge faces downward when the post is secured within the mounting hole in the bench block.

3. The work device of claim 1, wherein the bridge is connectable to the post on either the first end or the second end of the bridge.

4. The work device of claim 3, wherein
an engaging face is located on the suspended portion between the two connection ends, and
the two connection ends are comprised of the first material.

5. The work device of claim 1, further comprising a second post connectable to the second end of the bridge.

6. The work device of claim 5, wherein the second post is structured and configured to threadedly secure within a second mounting hole in the bench block.

7. The work device of claim 1, further comprising a locking device that is affixed to the post, wherein the bridge is located between the locking device and the bench block when the post is secured within the mounting hole on the bench block.

8. The work device of claim 1, further comprising the bench block, wherein the bench block includes
the first recess of a top side of the bench block, the first recess including a first through-hole positioned within the first recess, and
the at least one mounting hole.

9. A work device comprising:
a bench block having a receiving core, a top side and a bottom side:
the receiving core defining at least a first recess on the top side configured to securely receive a device component for performance of a maintenance operation, and
the receiving core further defining at least
a first through-hole positioned within the first recess of the receiving core, such that when a securing component is removed from the device component, the securing component passes through the first through-hole from the top side to the bottom side of the receiving core, and
at least one mounting hole; and
a vertically adjustable clamping device having
a post structured and configured to secure within the at least one mounting hole in the bench block, and
a bridge connected on a first end to the post and having a suspended portion between the first end and a second end, wherein the bridge has a length that spans across a width of the first recess when the post is secured within the at least one mounting hole.

10. The work device of claim 9, wherein the securing component is a pin.

11. The work device of claim 9, wherein
the bridge has an adjustable height along the post, and
the clamping device is further comprised of a locking mechanism that secures the bridge at a maximum height.

12. The work device of claim 9, wherein the at least one mounting hole and the post are threadedly connected.

13. The work device of claim 12, wherein the bench block has a second recess on the top side configured to securely receive a device component for performance of a maintenance operation.

14. The work device of claim 13, wherein the at least one mounting hole is positioned between the first recess and the second recess such that the bridge, when the post is secured within the mounting hole, spans across the width of the first recess when the bridge is in a first position, and spans across a width of the second recess when the bridge is in a second position.

15. The work device of claim 9, wherein
the bench block has a first mounting hole and a second mounting hole, and
the mounting holes are compatible with the post of the clamping device.

16. The work device of claim 15, wherein the first mounting hole and the second mounting hole are positioned opposite each other on either side of the first recess.

17. The work device of claim 16, wherein the work device is comprised of a second post that is structured and configured to secure within either of the mounting holes.

18. The work device of claim 17, wherein
the post of the first vertically adjustable clamping device is secured within the first mounting hole, and
the second post is secured within the second mounting hole.

19. The work device of claim 18, wherein
the posts are threadedly connected to their respective mounting holes,
the bridge of the first vertically adjustable clamping device has an adjustable height along the first post, and
the bridge of the first vertically adjustable clamping device has a first end connected to the first post and a second end connected to the second post.

20. The work device of claim 9, wherein
the bench block further includes a tray and a locking mechanism,
the tray is magnetized and is comprised of designated engagement portions that hold predetermined tools in place, and
the locking mechanism is a slide lock.

21. A work device comprising:
a bench block having a receiving core, a top side and a bottom side:
the receiving core defining at least a first recess on the top side configured to securely receive a device component for performance of a maintenance operation, and
the receiving core further defining at least
a first through-hole positioned within the first recess of the receiving core, such that when a securing component is removed from the device component, the securing component passes through the first through-hole from the top side to the bottom side of the receiving core, and
a plurality of mounting holes; and
a vertically adjustable clamping device having
a first post structured and configured to secure within a first mounting hole,
a second post structured and configured to secure within a second mounting hole, and
a bridge connected to the first post and the second post and having a suspended portion that spans across a width of the first recess when the posts are secured within the first and the second mounting holes.
